(19) United States
(12) Patent Application Publication
(10) Pub. No.: US 2026/0139758 A1
(43) Pub. Date: May 21, 2026

(54) FLOW CONTROL DEVICE WITH MULTIPLE SOLENOID VALVE

(71) Applicant: HSIANG-CHIEH WENG, Taipei City (TW)

(72) Inventor: HSIANG-CHIEH WENG, Taipei City (TW)

(21) Appl. No.: 19/391,722

(22) Filed: Nov. 17, 2025

(30) Foreign Application Priority Data
Nov. 21, 2024 (TW) 113144848

(51) Int. Cl. F16K 31/06; F16K 27/00

(52) U.S. Cl. CPC F16K 31/0675; F16K 27/003

(57) ABSTRACT

The present invention provides a flow control device with a plurality of solenoid valves, comprising a body, at least two flow ports, a first passage, a second passage, and at least two solenoid valves. The body has a fluid inlet and a fluid outlet, with the flow ports disposed inside the body having different hole diameters. The first passage connects the fluid inlet to the flow ports, and the second passage connects the flow ports to the fluid outlet. Each solenoid valve includes a coil, a static iron core, a moving iron core, a valve, and a spring, where each solenoid valve can independently control the opening or closing of its corresponding flow port. When there are n flow ports, each paired with n solenoid valves, the various combinations of solenoid valves can generate 2n distinct flow rates, thereby providing more precise flow control.

### CROSS-REFERENCE TO RELATED APPLICATION

This application claims priority to Taiwan Invention patent application No. 113144848, filed on Nov. 21, 2024, the entire disclosure of which is hereby incorporated by reference.

### BACKGROUND OF THE INVENTION

### 1. Field of the Invention

The present invention relates to a fluid control device, and more particularly to a flow control device configured to control the amount of fluid flow by means of at least two sets of solenoid valves.

### 2. Description of the Prior Art

Flow control is an important issue in industrial fluid equipment. Conventional fluid control typically employs a single solenoid valve to control whether the fluid is allowed to pass. However, such a control approach only enables simple on/off control and is incapable of precisely adjusting the flow rate of the fluid.

In order to address the aforementioned problem, the prior art provides a type of flow control device that utilizes an adjustable valve opening to control the flow rate of a fluid. By varying the degree of valve opening, the fluid flow rate can be regulated. However, such an approach requires a more complex mechanical structure to adjust the valve opening, which not only increases manufacturing costs but also tends to compromise control precision due to mechanical component wear.

Another conventional approach involves using variable-frequency control to adjust the flow rate, wherein the flow control is achieved by regulating the opening duration of the solenoid valve. However, this method requires a more complex circuit design and, in applications demanding rapid response, the control performance may be adversely affected due to the switching delay of the solenoid valve.

Furthermore, some commercially available flow control devices utilize servo motors to regulate valve openings. Although such devices can achieve relatively precise flow control, they are costly and require a more complex control system, which increases maintenance difficulty. Additionally, in harsh working environments, their control accuracy tends to degrade due to the influence of dust or moisture.

In view of the foregoing, in order to overcome the deficiencies of conventional flow control devices, the inventors of the present invention conducted extensive research and development, and ultimately devised a flow control device with multiple solenoid valves. The present invention provides a flow control device comprising a plurality of solenoid valves, which controls the flow of fluid by utilizing at least two solenoid valves with unequal flow capacities. This allows for precise flow control without requiring complex mechanical structures or circuit designs. Furthermore, by enabling different combinations of solenoid valve activations, the invention can generate a variety of flow rates, thereby reducing manufacturing costs and maintenance difficulty while improving the accuracy of flow regulation, effectively overcoming the shortcomings of the prior art.

### SUMMARY OF THE INVENTION

The objective of the present invention is to overcome the drawbacks of flow control devices in the prior art. In existing technologies, a single solenoid valve can only perform on/off control and cannot precisely adjust the flow rate. Mechanically adjustable valve structures are complex and prone to wear. Variable frequency control methods require complicated circuitry and suffer from response delays. Servo motor-based control systems are costly and difficult to maintain.

To achieve the aforementioned objective, the present invention provides a flow control device with multiple solenoid valves, comprising: a main body having a fluid inlet and a fluid outlet; at least two flow orifices disposed within the main body, wherein the flow orifices have different aperture sizes; a first conduit disposed within the main body and connecting the fluid inlet to the flow orifices; a second conduit disposed within the main body and connecting the flow orifices to the fluid outlet; and at least two sets of the solenoid valves, each configured to respectively control a corresponding flow orifice.

In one embodiment of the present invention, each solenoid valve comprises: a coil; a stationary iron core disposed within the coil; a movable iron core movably disposed at one end of the stationary iron core; a valve connected to the movable iron core; and a spring abutting against the valve for keeping the valve in a position that closes the corresponding flow orifice. When the coil is energized, the stationary iron core and the movable iron core attract each other, thereby driving the valve to open the corresponding flow orifice, such that fluid flows from the fluid inlet through the first conduit, passes through the opened flow orifice, and then flows through the second conduit toward the fluid outlet.

In one embodiment of the present invention, the coil simultaneously surrounds the stationary iron core and a portion of the movable iron core.

In one embodiment of the present invention, the body includes a front cover and a rear cover, wherein the fluid inlet and the fluid outlet are both disposed on the front cover.

In one embodiment of the present invention, the flow holes are arranged in parallel within the body.

In one embodiment of the present invention, the solenoid valves are independently controllable to open or close

In one embodiment of the present invention, the flow holes include n flow holes, and the solenoid valves include n sets of solenoid valves, where n is an integer equal to or greater than 2. The combinations of opened flow holes are capable of generating 2ⁿ different flow rates.

In one embodiment of the present invention, when the coil is de-energized, the spring pushes the valve to close the corresponding flow hole.

In one embodiment of the present invention, the fluid may be a gas or a liquid.

In one embodiment of the present invention, the apertures have diameters that increase sequentially.

With the aforementioned structure, the flow control device with multiple solenoid valves provided by the present invention offers the following advantages:
1. By using multiple apertures with different diameters in combination with solenoid valve control, multiple distinct flow rate combinations can be achieved;
2. Simple structure without the need for complex mechanical components or circuit designs;
3. Easy maintenance, reducing maintenance costs;
4. Fast response without delay issues;
5. Low manufacturing cost and economically feasible;
6. Suitable for precise flow control of either gases or liquids.

### BRIEF DESCRIPTION OF THE DRAWINGS

FIG. 1A is a perspective view of the flow control device with multiple solenoid valves according to the present invention;

FIG. 1B is another perspective view of the flow control device with multiple solenoid valves according to the present invention;

FIG. 2 is a schematic diagram of the flow control device with multiple solenoid valves according to the present invention;

FIG. 3 is a cross-sectional view of the flow control device with multiple solenoid valves according to the present invention;

FIG. 4 is an enlarged view of the region X in FIG. 3; and

FIG. 5 is a data curve graph showing the flow rate per minute corresponding to different combinations of solenoid valves.

### DETAILED DESCRIPTION OF THE PREFERRED EMBODIMENTS

To provide a clearer description of the flow control device with multiple solenoid valves proposed by the present invention, the following detailed explanation of a preferred embodiment is given in conjunction with the accompanying drawings.

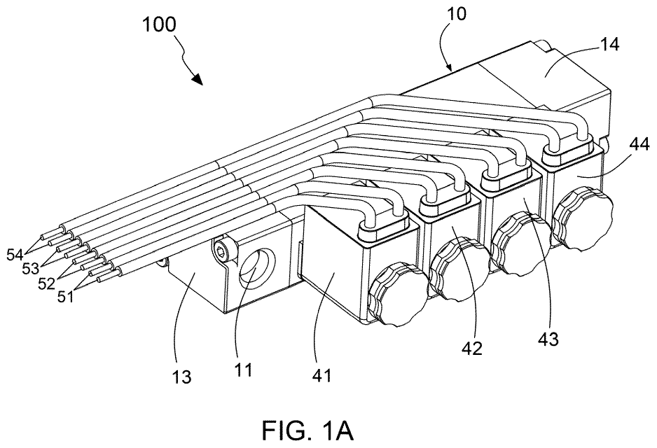

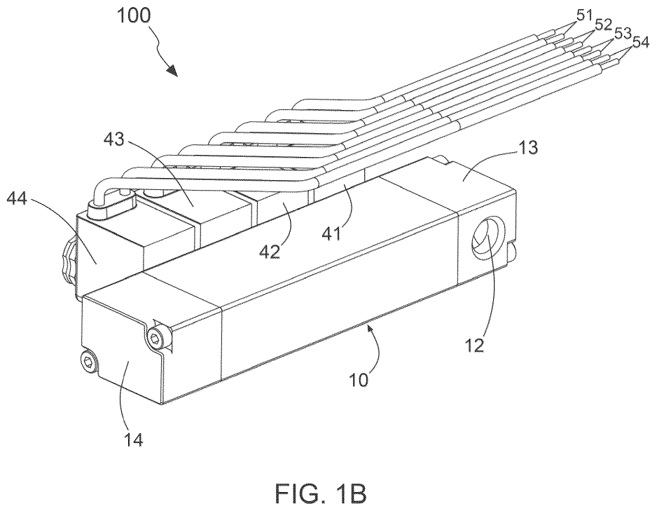

Referring to FIGS. 1A and 1B, the flow control device 100 with multiple solenoid valves according to the present invention includes a body 10, a front cover 13, and a rear cover 14. The body 10 is provided with a fluid inlet 11 and a fluid outlet 12, both of which are disposed on the front cover 13. The flow control device 100 further includes at least two sets of solenoid valves. In the present embodiment, four sets of solenoid valves are provided: a first solenoid valve 41, a second solenoid valve 42, a third solenoid valve 43, and a fourth solenoid valve 44, each having corresponding wiring: a first wire 51, a second wire 52, a third wire 53, and a fourth wire 54. The interior of the body 10 allows fluid to flow through it, and the fluid may be either a gas or a liquid.

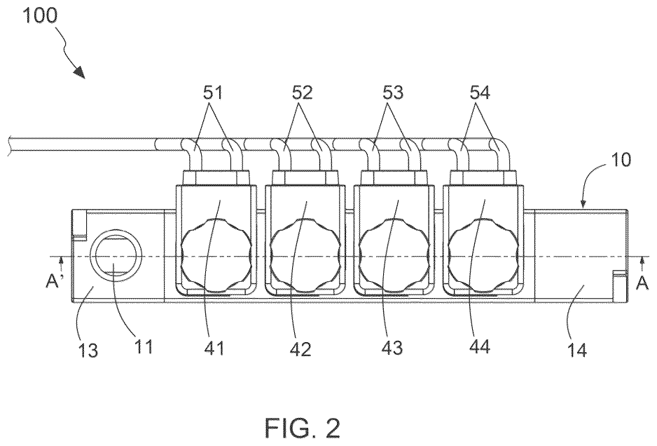

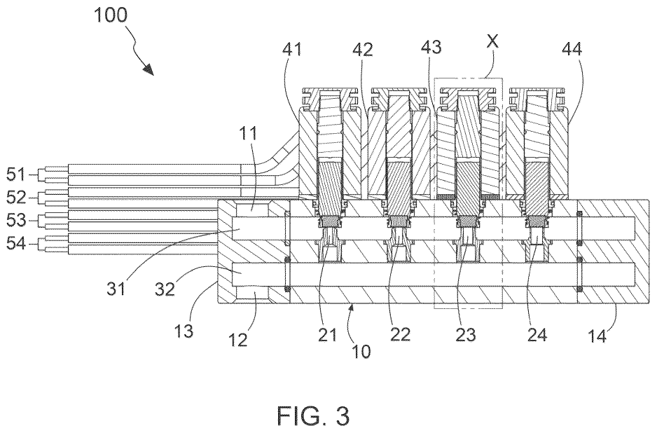

Referring to FIG. 2, the body 10 of the flow control device 100 is provided with the first solenoid valve 41, the second solenoid valve 42, the third solenoid valve 43, and the fourth solenoid valve 44. It is clearly shown that the first wire 51, the second wire 52, the third wire 53, and the fourth wire 54 are respectively connected to the corresponding first solenoid valve 41, second solenoid valve 42, third solenoid valve 43, and fourth solenoid valve 44. The fluid inlet 11 is disposed on the body 10. The drawing also indicates the sectional view position A-A, which will be used in FIG. 3 to illustrate the internal structure of the flow control device 100. The first solenoid valve 41, second solenoid valve 42, third solenoid valve 43, and fourth solenoid valve 44 can be independently controlled to open or close, thereby enabling different flow rate controls.

FIG. 3 is a sectional view along line A-A of FIG. 2. Referring to FIG. 3, the body 10 of the flow control device 100 is internally provided with at least two flow holes. In this embodiment, four flow holes are provided: a first flow hole 21 (smallest diameter), a second flow hole 22 (small diameter), a third flow hole 23 (large diameter), and a fourth flow hole 24 (largest diameter). These flow holes have different aperture sizes and are arranged in parallel within the body 10. The diameters of the flow holes increase sequentially. The body 10 is also provided with a first conduit 31 and a second conduit 32. The first conduit 31 is disposed inside the body 10 and connects the fluid inlet 11 to the first flow hole 21, the second flow hole 22, the third flow hole 23, and the fourth flow hole 24. The second conduit 32 is disposed inside the body 10 on the side opposite to the first conduit 31, and connects the first flow hole 21, the second flow hole 22, the third flow hole 23, and the fourth flow hole 24 to the fluid outlet 12. The first solenoid valve 41 controls the first flow hole 21, the second solenoid valve 42 controls the second flow hole 22, the third solenoid valve 43 controls the third flow hole 23, and the fourth solenoid valve 44 controls the fourth flow hole 24.

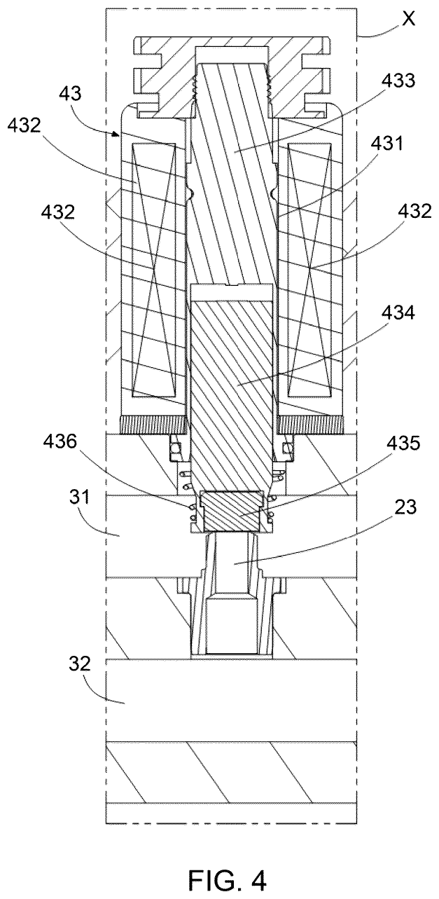

Referring to FIG. 4, which is an enlarged view of region X of FIG. 3, the structures and operations of the first solenoid valve 41, the second solenoid valve 42, the third solenoid valve 43, and the fourth solenoid valve 44 are identical. Taking the third solenoid valve 43 as an example, it includes: a solenoid tube 431, inside which a coil 432 is disposed. The coil 432 simultaneously surrounds a stationary iron core 433 and a portion of a movable iron core 434. The stationary iron core 433 is disposed within the coil 432. The movable iron core 434 is movably disposed at one end of the stationary iron core 433. A valve 435 is connected to the movable iron core 434, and a spring 436 abuts the valve 435 to keep the valve 435 in a closed state, thereby closing the third flow hole 23. When the coil 432 is energized, the stationary iron core 433 and the movable iron core 434 attract each other, thereby driving the valve 435 to open the corresponding third flow hole 23. This allows fluid to flow from the fluid inlet 11 through the first conduit 31, pass through the opened third flow hole 23, and then flow through the second conduit 32 toward the fluid outlet 12. When the coil 432 is de-energized, the spring 436 pushes the valve 435 to close the third flow hole 23.

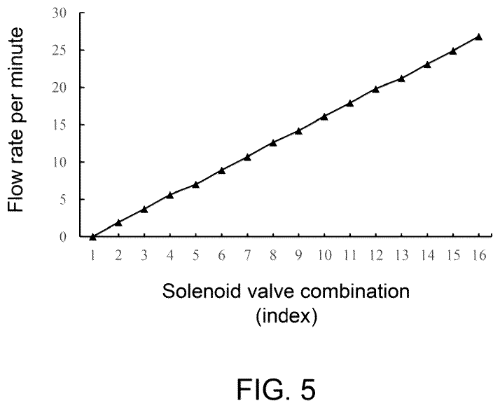

Furthermore, Table (1) records the data of various combinations of solenoid valves and their corresponding flow rates per minute, and FIG. 5 illustrates a data curve chart showing the flow rate per minute corresponding to different solenoid valve combinations.

TABLE 1

| | First | Second | Third | Fourth | |
|---|---|---|---|---|---|
| Combination | Solenoid | Solenoid | Solenoid | Solenoid | Flow rate |
| No. | Valve | Valve | Valve | Valve | per minute |
| 1 | 0 | 0 | 0 | 0 | 0 |
| 2 | 0 | 0 | 0 | 1 | 1.9 |
| 3 | 0 | 0 | 1 | 0 | 3.7 |
| 4 | 0 | 0 | 1 | 1 | 5.6 |
| 5 | 0 | 1 | 0 | 0 | 7 |
| 6 | 0 | 1 | 0 | 1 | 8.9 |
| 7 | 0 | 1 | 1 | 0 | 10.7 |
| 8 | 0 | 1 | 1 | 1 | 12.6 |
| 9 | 1 | 0 | 0 | 0 | 14.2 |
| 10 | 1 | 0 | 0 | 1 | 16.1 |
| 11 | 1 | 0 | 1 | 0 | 17.9 |
| 12 | 1 | 0 | 1 | 1 | 19.8 |
| 13 | 1 | 1 | 0 | 0 | 21.2 |
| 14 | 1 | 1 | 0 | 1 | 23.1 |
| 15 | 1 | 1 | 1 | 0 | 24.9 |
| 16 | 1 | 1 | 1 | 1 | 26.8 |

When the flow orifices include n flow orifices and n sets of solenoid valves are provided, where n is an integer greater than or equal to 2, the opening combinations of the flow orifices can generate 2ⁿ different flow rates. In this embodiment where n=4, the vertical axis represents the flow rate (L/min), and the horizontal axis represents different combination numbers, resulting in a total of 16 different flow rate combinations. By controlling the on/off combinations of the first solenoid valve 41, the second solenoid valve 42, the third solenoid valve 43, and the fourth solenoid valve 44, precise flow rate control can be achieved. For example, when only the first solenoid valve 41 is turned on, the minimum flow rate is obtained through the corresponding smallest first flow orifice 21; when both the first solenoid valve 41 and the second solenoid valve 42 are turned on, the total flow rate of the smallest first flow orifice 21 and the small second flow orifice 22 is obtained; and so on, until all of the first, second, third, and fourth solenoid valves (41-44) are simultaneously turned on to achieve the maximum flow rate.

In summary, the key design features of the present invention, a flow control device with multiple solenoid valves, are as follows:
1. At least two sets of solenoid valves are employed, with each solenoid valve individually controlling a flow orifice having a different aperture size. In the embodiment of the present invention, four sets of solenoid valves (namely, the first solenoid valve 41, the second solenoid valve 42, the third solenoid valve 43, and the fourth solenoid valve 44) respectively control four flow orifices with different aperture sizes (namely, the first flow orifice 21, the second flow orifice 22, the third flow orifice 23, and the fourth flow orifice 24);
2. A first pipeline 31 and a second pipeline 32 are disposed within the body 10 to connect the fluid inlet 11 to each of the flow orifices, and to connect each of the flow orifices to the fluid outlet 12, thereby forming a complete fluid flow path;
3. Each solenoid valve is designed such that its coil simultaneously surrounds a portion of both a stationary iron core and a movable iron core, and a spring is used to keep the valve in a normally closed position. The corresponding flow orifice is opened only when the coil is energized;
4. All solenoid valves can be independently controlled to open or close. When there are n flow orifices, 2ⁿ different flow rate combinations can be generated. In this embodiment, where n=4, a total of 16 different flow rates can be achieved, enabling precise flow control;
5. The flow control device features a simple structure and is easy to maintain. It does not require complex mechanical structures or circuit designs, yet it enables precise flow control functions suitable for both gas and liquid flow regulation.

The above description has fully and clearly disclosed an embodiment of the present invention, namely, a flow control device with multiple solenoid valves. It must be emphasized that the detailed description provided above pertains to a feasible embodiment of the present invention and is not intended to limit the scope of the present patent. Any equivalent implementations or modifications that do not depart from the technical spirit of the present invention shall be encompassed within the scope of the present patent.

What is claimed is:

1. A flow control device comprising multiple solenoid valves, comprising:
a body having a fluid inlet and a fluid outlet;
at least two flow apertures disposed within the body, wherein the flow apertures have different aperture sizes;
a first pipeline disposed within the body and configured to connect the fluid inlet to the flow apertures;
a second pipeline disposed within the body and configured to connect the flow apertures to the fluid outlet; and
at least two sets of solenoid valves, each solenoid valve comprising: a coil; a stationary iron core disposed within the coil; a movable iron core movably disposed at one end of the stationary iron core; a valve connected to the movable iron core; and a spring abutting the valve to keep the valve in a closed position against the corresponding flow aperture;
wherein each solenoid valve is configured to correspondingly control one of the flow apertures; wherein, when the coil is energized, the stationary iron core and the movable iron core attract each other, thereby driving the valve to open the corresponding flow aperture, so that a fluid flows from the fluid inlet through the first pipeline, through the opened flow aperture, and then through the second pipeline to the fluid outlet.

2. The flow control device according to claim 1, wherein the coil simultaneously surrounds the stationary iron core and a portion of the movable iron core.

3. The flow control device according to claim 1, wherein the body comprises:
a front cover; and
a rear cover;
wherein the fluid inlet and the fluid outlet are both disposed on the front cover.

4. The flow control device according to claim 1, wherein the flow orifices are arranged in parallel.

5. The flow control device according to claim 1, wherein the solenoid valves are independently controllable to open or close.

6. The flow control device according to claim 1, wherein the flow holes comprise n flow holes, and the solenoid valves comprise n sets of solenoid valves, n being an integer greater than or equal to 2, wherein combinations of opened flow holes are capable of generating 2ⁿ different flow rates.

7. The flow control device according to claim 1, wherein when the coil is de-energized, the spring pushes the valve to close the corresponding flow hole.

8. The flow control device according to claim 1, wherein the fluid is a gas or a liquid.

9. The flow control device according to claim 1, wherein the diameters of the flow holes increase sequentially.
